(19) United States
(12) Patent Application Publication
(10) Pub. No.: US 2005/0254772 A1
(43) Pub. Date: Nov. 17, 2005

(54) Light pipe assembly for use with small form factor connector

(76) Inventors: Jerry A. Long, Elgin, IL (US); Kent E. Regnier, Lombard, IL (US)

Correspondence Address: MOLEX INCORPORATED, 2222 WELLINGTON COURT, LISLE, IL, 60532, US

(21) Appl. No.: 11/130,667

(22) Filed: May 16, 2005

Related U.S. Application Data
(60) Provisional application No. 60/571,375, filed on May 14, 2004.

(51) Int. Cl. G02B 6/10

(52) U.S. Cl. 385/146

(57) ABSTRACT

A light pipe assembly is provided for use with small form factor style connectors of a dual row, stacked configuration. The assembly includes two pairs of light pipes, each of which is provided with integrated support members. The support members engage either a connector housing or exterior shield used to house the connector,

### REFERENCE TO RELATED APPLICATIONS

This application claims priority of prior U.S. Provisional Patent Application No. 60/571,375, filed May 14, 2004.

### BACKGROUND OF THE INVENTION

This invention relates to electrical connector assemblies and, more particularly, to an electrical connector assembly that has an indicator light pipe assembly associated therewith.

Electrical connectors adapted for mounting to printed circuit boards are known in the art and are commonly used for connection between two electrical communication devices. In order to ensure that a proper connection has been made and therefore a link is created between the electrical communication devices, indicators may be incorporated into circuits on the printed circuit board. These indicators are typically light emitting diodes (LEDs) which are turned on when a circuit is completed between the mating connectors and the communication devices. Additionally LEDs can be mounted on the printed circuit board to indicate a number of other conditions including the passage of communications signals between the two communication devices, indication of power, or indication that an error in transmitting the signals has occurred.

In an effort to miniaturize printed circuit boards and save board real estate, light pipe assemblies for transmitting light emitted by the LED's have been integrated into connector assemblies. One example of such a connector assembly is disclosed in U.S. Pat. No. 5,876,239 to Morin et al. which teaches a modular jack receptacle connector having a light pipe for transmitting light signals from an input face of the light pipe through an output face of the pipe extending along a mating face of the modular jack receptacle.

A problem arises with these connectors in that the tooling used to produce the connector housing may require modification to enable incorporation of the light pipes into the connector housing. Another problem is that incorporation of the light pipes into the connector assembly tends to increase the footprint of the connector, thereby increasing the printed circuit board “real estate” occupied by the connector.

The present invention is therefore directed to a light pipe assembly that overcomes the aforementioned disadvantages and which fits either alongside a stacked connector assembly or first within the space between two connector engagement areas of a connector component and further extends forwardly from the connector component in a space between two bays associated with the connector component which receive electronic modules therein.

### SUMMARY OF THE INVENTION

Accordingly, it is a principal object of the present invention to provide a light transmission assembly that may be used with connectors that are stacked upon each other or which have engagement faces spaced vertically apart.

Another object of the present invention is to provide a light pipe assembly that may be utilized with a dual engagement connector component having two engagement areas vertically spaced apart from each other on the component and which are each surrounded by a metal shield component, the shield component defining two distinct module-receiving bays which are separated by an intervening space, the light pipe assembly extending from the connector component forwardly through the intervening space to provide at least a pair of indicator lights near the front of the module-receiving bays, the light pipe assembly engaging the sides or front of the connector component.

A further object of the present invention is to provide a light pipe assembly of the type described above wherein the assembly includes two pairs of light pipes, the light pipes of each pair being arranged in tandem and vertically spaced apart from each other, the light pipes extending upward from the circuit board and then alongside a connector assembly.

A further object of the present invention is to provide a light pipe assembly of the type described above wherein the assembly includes two pairs of light pipes, each pair extending from the connector component through the intervening space and ends of the light pipes being received within a spacer head that positions the ends of the light pipes proximate to the front of the module receiving bays, both the light pipes and the spacer head being disposed within a space between two module-receiving bays of the overall connector assembly.

The present invention accomplishes these and other object by way of its structure. In one principal aspect of the present invention and as exemplified by a first embodiment of the invention, two pairs of light pipes are provided and each of which acts as an “On” or “Off” indicator light for an electronic module that is engageable with an associated connector component. The light pipes extend between first ends that are aligned with illuminating areas on the circuit board and second ends that are exposed to the exterior of the associated connector component. Each pair of light pipes is stacked above each other and the pair are interconnected by engagement members that engage a shield assembly that encloses the connector component and defines two spaced apart module-receiving bays.

In this embodiment, the pairs of light pipes may extend alongside the connector component and further may extend alongside the shield assembly that encloses the connector component.

In another embodiment of the present invention, the light pipe pairs are formed with engagement members that engage the sides of the associated connector component, and the second ends of the light pipes extend forwardly of the connector component into an intervening space which is disposed between the two module-receiving bays, the second ends being received with an endcap member that occupies the front area of the intervening space. The endcap is preferably formed from a conductive material in order to provide shielding at the front of the connector assembly.

In another embodiment of the present invention, the light pipes extend up from the circuit board and then turn at angle so they extend lengthwise of the connector component. The light pipes extend horizontally and forwardly past a front mating face of the connector component and the pairs of light pipes are nested within each other. In this fashion, the entire horizontal portion of the light pipes may be maintained in a bay that separates the two module-receiving bays of the connector component.

These and other objects, features and advantages of the present invention will be clearly understood through a consideration of the following detailed description

### DESCRIPTION OF THE DRAWINGS

The invention will now be described by way of example with reference to the following figures of which:

FIG. 1 is an exploded perspective view of a portion of a connector assembly constructed in accordance with the principles of the present invention;

FIG. 2 is a perspective assembled view of the portion of the connector assembly shown in FIG. 1;

FIG. 3 is a perspective view of a connector housing incorporated into the assembly shown in FIG. 1;

FIG. 4 is perspective view of a first embodiment of a light pipe assembly that may be used with the connector assembly of FIGS. 1-3;

FIG. 5 is perspective view of a second embodiment of a light pipe assembly incorporated into the connector assembly of the present invention;

FIG. 6 is a perspective view of the light pipe assembly of FIG. 4 incorporated into the connector assembly, and extending along the sides thereof;

FIG. 7 is a partial cutaway perspective view showing the light pipe assembly of FIG. 5 incorporated into the connector assembly, and specifically disposed within the exterior shield assembly and partially within the space dividing the two module-receiving bays of the connector assembly; and,

FIG. 8 is the same view of the connector assembly of FIG. 7, but with the shield assembly exterior wall shown in place.

### DETAILED DESCRIPTION OF THE INVENTION

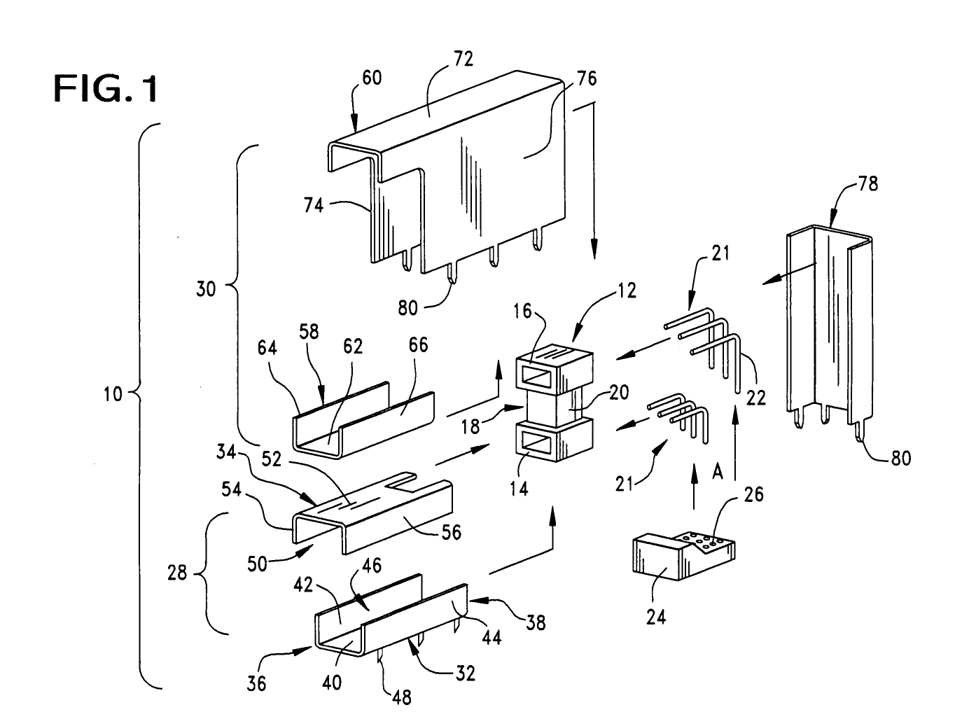

A connector assembly 10 of the present invention will now be described generally with reference to FIGS. 1-3. The connector assembly 10 is designed for mounting on a printed circuit board 11. Connector assembly 10 comprises a connector housing 12 defining a pair of ports 14, 16 each adapted for receiving a portion of a mating connector (not shown). Herein, the housing port 14 will be referred to as the “lower port”, and housing port 16 will be referred to as the “upper port”, but it will be understood that such terms as “upper”, “lower”, etc. are used in this description to facilitate an understanding of the invention and are not intended to be limiting.

Upper and lower ports 14, 16 each have a plurality of conductive terminals 21 mounted therein for engaging complementary terminals of a mating connector (not shown). To permit space for latching mechanisms for releasably securing connector assembly 10 in a mated condition with a complementary mating connector, a cavity 18 may be formed between upper port 16 and lower port 14 of connector housing 12. Recesses 20 may be formed in side portions of housing 12, for purposes to be described below. Recesses 14 may be in communication with housing cavity 18.

Connector housing 12 may be molded from an insulative, thermoplastic material. The terminals are mounted in the upper port 16 and the lower port 14 and each terminal has contact portions at an end thereof (not shown) for engaging complementary contact portions of the terminals of the mating connector, and tail portions 22 projecting rearwardly from the contact portions and extending downwardly toward printed circuit board 11 for electrical connection to respective traces thereon via through holes formed in (or surface mount pads formed on a surface of) printed circuit board 11. The terminals may be stamped and formed of sheet metal material.

A tail aligner 24 may be attached to connector housing 12 using any one of a variety of known methods, such as a snap-fit, press-fit or mechanical fasteners. The tail aligner 24 includes a plurality of through holes 26 formed therein and which are configured to match the arrangement of terminal tail portions 22 extending downward toward printed circuit board 11. The tail aligner 24 is mounted onto tail portions 22 of the terminals in the direction of arrow “A” (FIG. 1) and it sits on the surface of the circuit board 11.

A pair of shielding cage assemblies 28, 30 are secured to connector housing 12, with the cage assemblies including a lower cage assembly 28 that is secured to housing 12 to substantially enclose lower port 14 thereof, and an upper cage assembly 30 that is secured to the housing 12 to substantially enclose the upper port 16 thereof. The cage assemblies 28, 30 are typically formed using a material, such as sheet metal or plated plastic, which conducts and guides magnetic and electric field energy so as to aid in shielding circuit elements positioned proximate connector assembly 10 from electromagnetic interference (EMI).

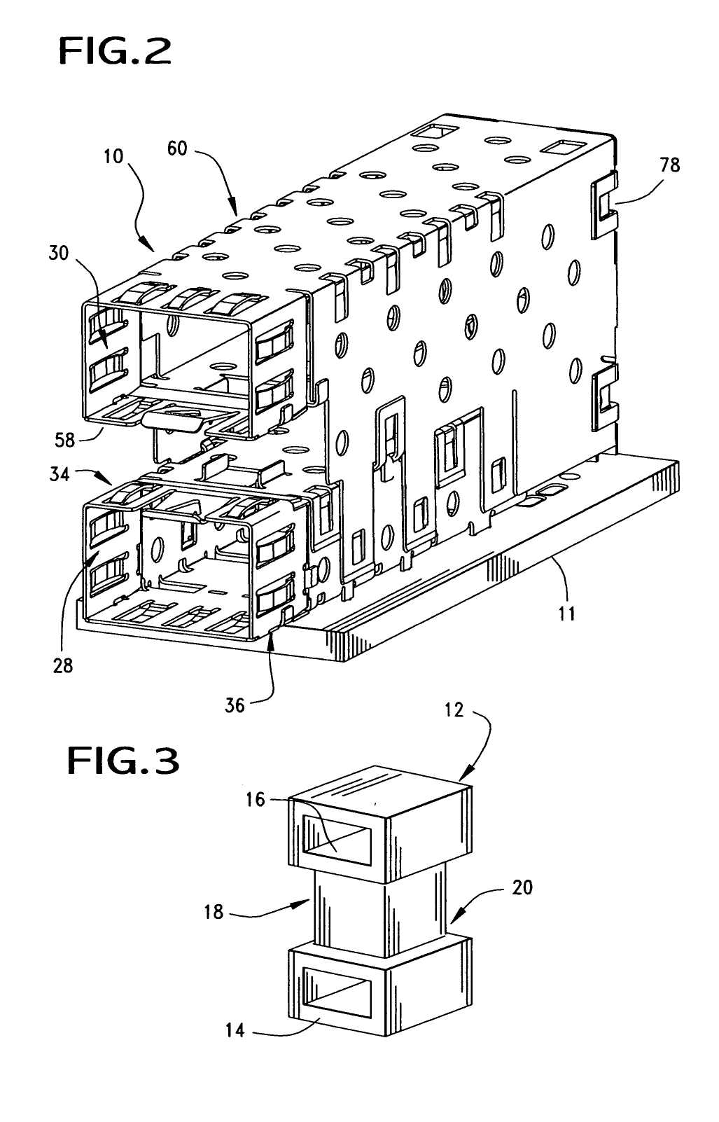

The lower cage assembly 28 typically includes two interengaging pieces, a lower base component 32 and a lower cover component 34. The lower base component 32 has a general U-shaped configuration when viewed from the front or rear ends, 36, 38 respectively. As such, the lower base component 32 typically includes three sides, or walls: a base or bottom wall 40 and two sidewalls 42, 44 that extend upwardly from the bottom wall 40 and which are spaced apart from each other to define a channel 46 therebetween, into which a portion of the connector housing 12 fits. As seen in FIGS. 1 and 2, the front and rear portions of lower base component 32 are left open.

In one embodiment, the lower base component 32 is stamped and formed from sheet metal. The lower base component 32 may alternatively be formed using conductive materials other than metal, such as metal-plated plastic or the like. Lower cover component 34 may also be formed using sheet metal or other conductive materials, such as metal-plated plastic. Generally, the cover component 34 has a length that matches a corresponding length of lower base component 32, and a width that is equal to or slightly greater than a corresponding width of the lower base component 32. The lower cover component 34 is bent, as illustrated, into a general U-shaped configuration when looking at it from its front end 50. In this fashion, it includes top wall 52 and two spaced-apart side walls 54, 56.

Lower base component 32 and lower cover component 34 interengage along respective sidewalls thereof the form an enclosure for at least partially enclosing lower housing Port 14 of connector housing therein. As seen in FIGS. 1 and 2, the front and rear portions of the lower cage assembly 28 are left open. The details of this type of shielding cage structure are provided in U.S. Pat. No. 6,443,768, entitled “Small Form Factor Connector Cage,” which issued on Sep. 3, 2002 and is incorporated herein by reference.

The structure of upper cage assembly 30 is substantially similar to that of the lower cage assembly 28. The upper cage assembly 30 typically includes two interengaging pieces, an upper base component 58 and an upper cover component 60. The upper base component 58 has a bottom wall 62 and two spaced-apart sidewalls 64, 66. The upper cover component 60 has a top wall 72 and two spaced apart sidewalls 74, 76. These sidewalls 74 and 76 interengage the upper base component as shown in order to form an enclosure similar to that formed by lower cage assembly 28, for at least partially enclosing an upper housing port 16 of the connector housing 12. In addition, sidewalls 74, 76 of upper cover component 60 also extend toward printed circuit board 11 to substantially enclose side portions of both upper cage assembly 30 and lower cage assembly 28. The lower base component 32 may be provided with mounting pin portions 48 that are stamped out of the bottom wall 40 thereof and which are formed, or bent, so that they extend vertically with respect to the lower base bottom wall 40, and generally in the same plane as the sidewalls 42, 44. The mounting pin portions 48 are formed in a desired pattern to engage and mate with corresponding mounting holes on printed circuit board 11. Similar mounting pin portions 80 may be formed to extend along lower edges of extended sidewalls 74, 76 of the cover member 60 to engage mounting holes in printed circuit board 11.

Connector assembly 10 also includes a separate rear wall 78 that is attachable to the upper and lower cage assemblies 28, 30. Rear wall may be formed from the same material as the cage assemblies and forms an enclosure surrounding the terminal tail portions 22, tail aligner 24 and the rear portion of connector housing 12 when attached to cage assemblies 28, 30. The rear wall 78 also includes mounting pin portions 80 that are stamped out of a bottom portion of rear wall 78 and formed, or bent, so that they extend vertically with respect to rear wall 78. The mounting pin portions 80 are formed in a desired pattern to engage and mate with corresponding mounting holes on printed circuit board 11.

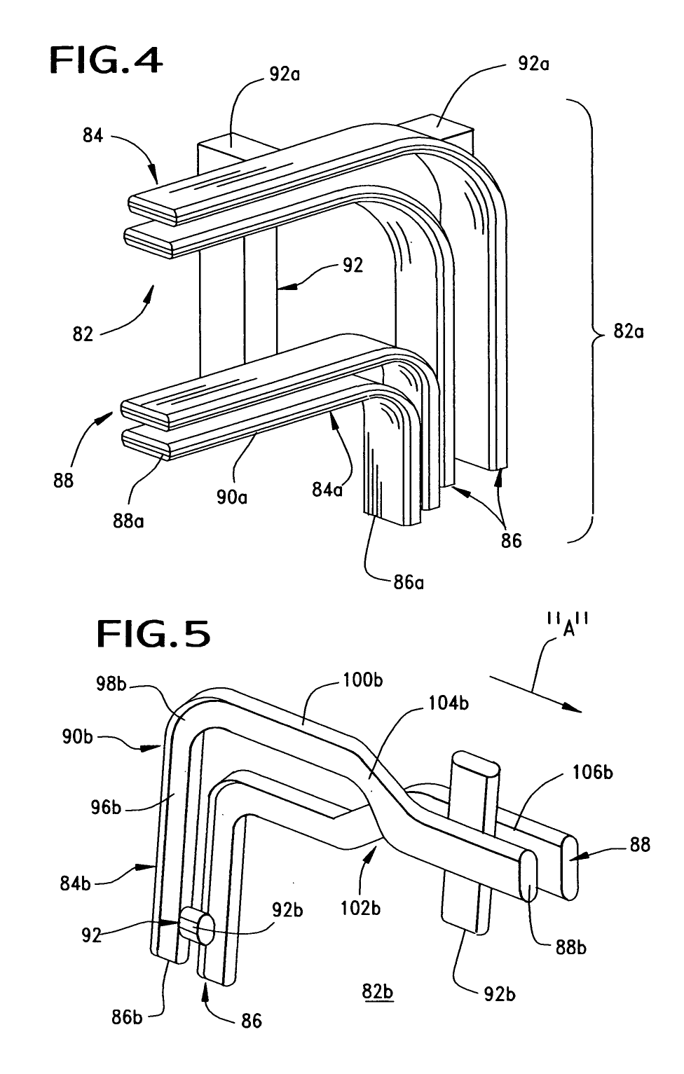

Referring to FIGS. 4-7, in another aspect of the present invention, a light pipe assembly, generally designated 82, is incorporated as part of the overall connector assembly 10. The light pipe assembly 82a of FIG. 4 will be referenced for the purpose of describing the basic components of the light pipe assemblies. However, it will be understood that light pipe assembly 82b of FIG. 5 has the same basic features as light pipe assembly 82a.

Light pipe assembly 82 includes at least one light pipe 84 manufactured from a translucent material suitable for carrying light, for example a plastic or glass. The pipes 84 are illustrated as arranged together in pairs of pipes, with each pair shown extending alongside the shielding cage assembly of the connector assembly. FIGS. 4 & 5 show light pipe assemblies which are formed using multiple light pipes arranged in distinct pairs of light pipes. Any one of the light pipes 84 may be color-coded, if desired, in order to distinguish it from other light pipes incorporated into the connector assembly. Each light pipe 84 has a light-receiving input face 86, a light emitting output face 88, and a body portion 90 extending between the input and output faces. Light pipes 84 are shaped to carry light signals from input faces 86 through body portions 90 to output faces 88.

Portions of light pipes 84 may be affixed to one or more support members 92. Support members 92 provide a framework for positioning and securing light pipes 84 with respect to each other and with respect to cage assemblies 28, 30. Thus, portions of support members 92 may be formed so as to enable engagement with features on one of cage assemblies 28, 30. Support members 92 may be formed integral with light pipes 84 as shown in the Figures or they may be separate members that are attached to the light pipes in a manner well known in the art by adhesion, welding and the like. When the light pipe assembly 82 is mounted to cage assemblies 28, 30, input faces 86 of each light pipe 84 will be positioned so as to reside opposite a respective light source (for example, a light emitting diode or “LED”) that is mounted on printed circuit board 11, and output faces 88 of each light pipe 84 will be positioned so as to reside opposite a respective light receiving element mounted on, for example, a mating connector or a chassis of an electronic component.

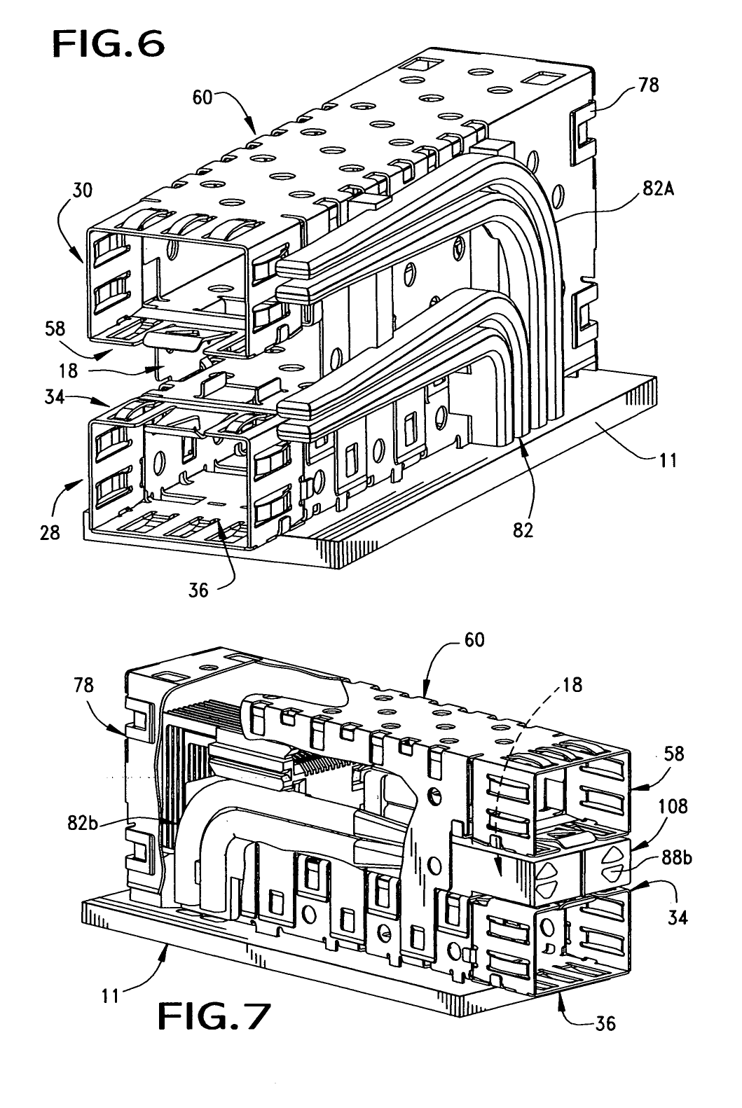

A first embodiment of the connector assembly of the present invention will now be described with reference to FIGS. 4 and 6. As shown in FIGS. 4 and 6, a first embodiment of the present invention, a light pipe assembly 82a is externally mounted with respect to cage assemblies 28, 30. FIGS. 4 and 6 show one possible configuration, in which two pairs of light pipes are spaced apart vertically and connected to a pair of support members 92a. Light pipe assembly 82a may be connected to one or more of the cage assemblies 28, 30 using any one of several known methods. Examples of possible attachment methods include a mating-type connection between complementary features formed in light pipe assembly 82a and cage assembly 28, 30, mechanical fasteners, or adhesives. A portion of light pipe assembly 82a may also be secured to printed circuit board. One or more light pipe assemblies 82a may also be mounted along multiple sides of connector assembly. Thus, a light pipe assembly 82a of the first embodiment may be configured in any desired manner to enable attachment to an existing connector assembly and to convey light between light emitting elements and light receiving elements having any one of a variety of spatial locations with respect to the connector assembly.

As may be seen from the above description, the shapes of light pipes 84a and the dimensions and positioning of support members 92a in this embodiment may be specified such that light may be conveyed between light emitting elements and light receiving sensors having a wide variety of locations in relation to connector assembly 10. For example, as seen in FIG. 6, the configurations of light pipes 84a and support members 92a may be specified such that light pipe input faces 86a will receive light from respective LED's positioned on printed circuit board 11 at various distances from connector assembly 10. Also, the configurations of light pipes 84a and support members 92a may be specified such that light pipe output faces 88a will emit light to light receiving sensors located at any one of a variety of distances from printed circuit board 11. As shown in FIG. 5, the bottom support member 92b may extend out from the pair of light pipes at an angle and have an engagement slot that engages a corresponding member on either the exterior shielding cage or the connector housing of the connector assembly.

A second embodiment of the present invention will now be described with reference to FIGS. 5, 7 and 8. Referring to FIG. 5 a light pipe assembly 82b may be provided that includes one or more pairs of individual light pipes arranged in pairs. Each assembly 82b can be seen to include a pair of adjacent light pipes 84b that are attached to one or more support members 92b. The light pipes 84b each opposing input faces 86b, output faces 88b and body portions 90b that extend between the input and output faces 86b, 88b. In this embodiment, the light pipes are configured to be mounted within the upper cage cover component 60 as shown by the alternate embodiment arranged in FIG. 7. In this embodiment, the pipes extends within the connector housing recess 20 and cavity 18 formed between housing upper port 16 and housing lower port 14. As shown in FIG. 5, each of the light pipes may include a first bend, shown as a right angle bend, and a second bend, shown as an offset bend interposed between the ends 86, 88 of the light pipes. The offset bends may include left to right angled portions 104b as explained in greater detail below.

The light pipe assembly 82b may extend along a portion of tail aligner 24, behind connector housing 12 and the light pipe assembly 82b may be secured to the connector housing 12 such that light pipe input faces 86b reside opposite respective LED's mounted on printed circuit board 11 and light pipe output faces 88b reside opposite respective light receiving sensors (not shown) mounted on a separate item of electronic equipment. Body portions 90b are formed so as to connect input faces 86b and output faces 88b for conveying light from LED's to the light receiving sensors located proximate output faces 88b.

As may be seen in FIG. 5, input faces 86b of light pipes 84b may be arranged in a “front-rear” configuration with respect to the mating direction of connector assembly 10 indicated by arrow “A”. The body portions 90b of the light pipes 84b include vertical portions 96b extending upward from printed circuit board 11 and terminating in right angle bends 98b. Horizontal portions 100b of light pipes 84b extend from right angle bends 98b toward a front portion of the connector assembly, terminating in a transition region, generally designated 102b. It may be seen from FIG. 5 that horizontal portions 100b extending forward from right angle bends 98b have an “over-and-under” orientation.

Referring to FIGS. 5 and 7, it may be desired to arrange output faces 88b of light pipes 84b in a “side-to-side” configuration with respect to the connector assembly mating direction. Thus, the configuration of light pipes 84b must transition from the “over-and-under” orientation of horizontal portions 100b to the “side-to-side” configuration. This transition is shown best in FIG. 5. The transition in the configuration of the light pipes between right angle bends 98b and output ends 88b is achieved by forming, in transition region 102b, angled portions 104b in each of the body portions of the light pipes. The transition region 102b preferably resides within housing cavity 18.

FIG. 5 shows one possible arrangement of angled portions 104b in transition region 102b. At points on the light pipe body portions 90b which are located within the housing cavity 18, the body portion 90b of the bottommost light pipe 84b angles inward and upward, while the body portion 90b of the top most light pipe 84b angles outward and downward. The straight sections 106b of the body portions 90b then proceed from angled portions 104b toward a front portion of connector assembly 10 proximate the connector receiving openings in cage assemblies 104b. As seen in FIG. 5, the body portions 90b may be angled such that straight sections 106b are spaced apart from each other and spaced approximately the same distance from printed circuit board 11.

A support member 92b may be positioned between body straight sections 106b proximate angled 104b to position and secure the light pipe straight sections 106b with respect to each other and with respect to connector housing 12. The width of support member 106b may be set to provide and maintain a desired predetermined spacing between straight sections 106b. Also, the length of support member 92b may be set to provide a press fit between upper cage base component 58 and lower cage cover component 34 when light pipe assembly 82b is inserted into the cavity 18 formed between the upper port 16 and lower port 14 of the connector housing. The support member 92b may also be plated with a metallic material to form a conductive member extending between upper cage assembly base component 58 and lower cage assembly cover component 34. This provides additional grounding contact between cage assemblies 28 and 30.

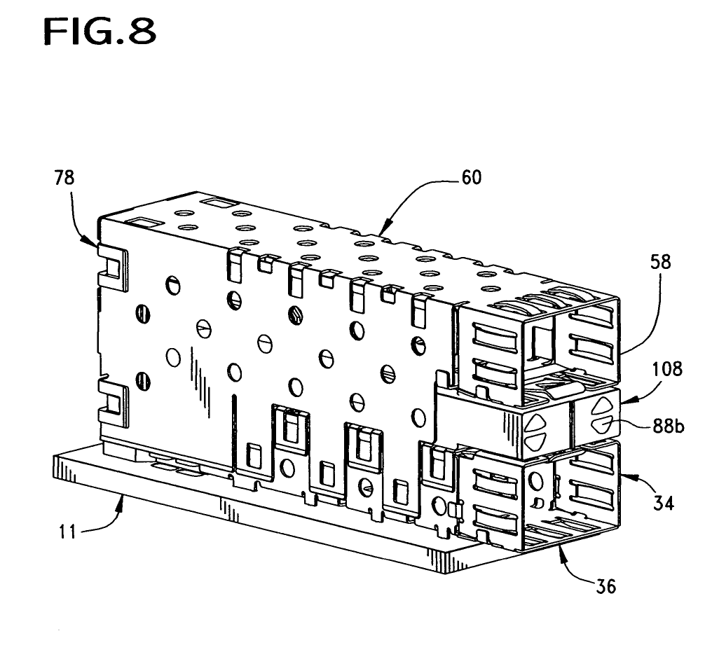

Referring to FIGS. 7 and 8, the portions of light pipe straight sections 106b which include output faces 88b may be received in a shroud, or endcap 108. The end cap 108 is preferably formed of a conductive material, such a metal alloy or a plated plastic, that will provide some degree of EM shielding. The endcap 108 is adapted to position and secure the light pipe output faces 88b and to provide additional EMI shielding for the connector assembly. The endcap also may ensure a proper alignment and spacing between the light pipes so that they will fit in the intervening space between the connector slots. For these purposes, the end cap 108 may be disposed to create intimate contact with both the upper cage assembly 58 and the lower cage assembly 36. Also, the shroud 108, along with cage assemblies 58, 36, will generally be connected to a grounding member located on printed circuit board 11 or a chassis of another electronic component.

In FIGS. 7 and 8, two light pipe assemblies 82b are embodied in two pairs of spaced apart light pipes 84b extending along opposite sides of connector housing 12. In this embodiment, the light pipe assemblies 82b reside within housing recesses 20, within upper cage cover component 60, and within the cavity 18 formed between upper port 16 and lower port 14. As such, the light pipe assembly 82b resides within the existing printed circuit board “footprint” of the connector assembly as defined by connector housing 12 and the cage assemblies that enclose the housing. Thus, this embodiment of the connector assembly incorporates a light pipe assembly therein without occupying additional space on printed circuit board 11.

Assembly of the first embodiment of connector assembly 10 will now be described with reference to FIGS. 1, 2 and 6. In a first step, the terminals are press-fit into connector housing 12. Terminal tail portions 22 are then inserted into tail aligner holes 26 and the tail aligner 24 is secured to connector housing 12, thereby securing tail portions 22 with respect to housing 12. The upper and lower cage assemblies 58, 36 are then secured over the connector housing 20 to upper and lower housing ports 14 and 16, respectively.

The rear wall 78 of the cage assembly is then attached to the shielding cage assembly over the upper and lower assemblies 30, 28 and the upper cover component 60 to enclose terminal tail portions 22, tail aligner 24 and to close off the rear portion of connector housing 12. The rear wall 78 is generally secured in intimate contact with one or more walls of each of upper cage assembly base component 58, upper cage assembly cover component 60, lower cage assembly base component 32 and lower cage assembly cover component 34. As stated previously, mounting pin portions 80 may also be formed on the shielding cage rear wall 78 in a desired pattern to engage and mate with corresponding mounting holes on the circuit board 11. These holes may be plated through holes which are electrically coupled to circuit traces on printed circuit board 11. These circuit traces are connected to one or more grounding features, thereby providing a grounding path for electromagnetic energy flowing through cage assemblies 28 and 30. After securing rear wall 78 to upper and lower cage assemblies 28 and 30, the connector assembly 10 may be electrically attached as a single unit to the printed circuit board 11.

Assembly of the second embodiment of connector assembly 12 will now be described with reference to FIGS. 1, 2, 7 and 8. In a first step, the terminals are press-fit into connector housing 12. Terminal tail portions 22 are then inserted into tail aligner holes 26 and tail aligner 24 is secured to connector housing 12, thereby securing tail portions 22 with respect to housing 12. In this embodiment, the lower cage assembly 28 is then secured to the connector lower housing port 14, and the base portion 58 of the upper cage assembly 30 is then attached to the connector upper housing port 16. The light pipe assembly 82b is then press-fit into housing recess 20 and the housing cavity 18. Upper cage assembly cover component 60 is then attached to upper cage assembly base component 60, thereby enclosing light pipe assembly 82b within side walls of upper cover component 60. The spacing between the upper and lower cage assemblies 30, 28 defines a cavity that extends lengthwise of the connector assembly and this cavity accommodates the horizontal extent of the light pipe assemblies.

The rear wall 78 may then attached to cage assemblies 28, 30 to enclose terminal tail portions, tail aligner 24 and the rear portion of connector housing 12 as described above. After securing rear wall 78 to upper and lower cage assemblies 30 and 28, connector assembly 10 may be electrically attached to printed circuit board 11.

While the preferred embodiment of the invention have been shown and described, it will be apparent to those skilled in the art that changes and modifications may be made therein without departing from the spirit of the invention, the scope of which is defined by the appended claims

1. A light pipe structure for use with an associated connector assembly that is surface mounted to a circuit board and the light pipe structure redirecting light from a plurality of light emitting elements supported by a circuit board, said light pipe structure, comprising:
a first pair of light pipes positioned adjacent each other and a second pair of light pipes positioned adjacent each other, the first and second pairs of light pipes being connected together by way of a first connecting member, each of said light pipes including opposing receiving and emitting ends; and,
means for attaching said first and second pairs of light pipes to the connector assembly.

2. The light pipe structure of claim 1, wherein the receiving and emitting ends being disposed at angles to each other.

3. The light pipe structure of claim 2, wherein each of said light pipes has an L-shape.

4. The light pipe structure of claim 1, wherein said first connecting member extends in a vertical direction and spaces said first and second pairs of light pipes apart in a vertical direction.

5. The light pipe structure of claim 1, wherein said attachment means is disposed on said first connecting member and is adapted to engage an exterior portion of said connector assembly.

6. The light pipe structure of claim 1, further including a second connecting member that connects said first and second pairs of light pipes together, the second connecting member being spaced apart from said first connecting member.

7. The light pipe structure of claim 6, wherein said first and second connecting members are spaced apart from each other in a horizontal direction.

8. The light pipe structure of claim 6, wherein said attachment means is also disposed on said second connecting member and is also adapted to engage an exterior portion of said connector assembly.

9. The light pipe structure of claim 1, wherein said connector assembly includes two receptacle portions space vertically apart from each other, and said first and second pairs of light pipes extend horizontally between the two receptacle portions of said connector assembly.

10. The light pipe structure of claim 1, further including an endcap member that engages said emitting ends and at least partially encloses them.

11. The light pipe structure of claim 10, wherein said endcap member is conductive.

12. The light pipe structure of claim 1, wherein each of the first and second pairs of light pipes includes two bends interposed between their receiving and emitting ends.

13. The light pipe structure of claim 12, wherein one of said bends in a right angle bend and the other of said two bends is an offset bend.
